(19) United States
(12) Patent Application Publication
(10) Pub. No.: US 2026/0322636 A1
(43) Pub. Date: Oct. 15, 2026

(54) INFORMATION PROCESSING METHOD, INFORMATION PROCESSING DEVICE, INFORMATION DISPLAY DEVICE, AND INFORMATION PROCESSING PROGRAM

(71) Applicant: FUJIFILM Corporation, Tokyo (JP)

(72) Inventors: Yutaka OISHI, Kanagawa (JP); Shinnosuke SONODA, Kanagawa (JP); Sae NESHIBA, Kanagawa (JP); Shohei YANO, Kanagawa (JP); Yuji AKADA, Kanagawa (JP); Atsushi ITO, Kanagawa (JP); Yuko MASUDA, Kanagawa (JP)

(73) Assignee: FUJIFILM Corporation, Tokyo (JP)

(21) Appl. No.: 19/690,449

(22) Filed: May 28, 2026

Related U.S. Application Data
(63) Continuation of application No. PCT/JP2024/039162, filed on Nov. 1, 2024.

(30) Foreign Application Priority Data
Nov. 30, 2023 (JP) 2023-203244

(51) Int. Cl. H04L 9/00

(52) U.S. Cl. CPC H04L 9/50

(57) ABSTRACT

An information processing device acquires one or more pieces of data, acquires a hash tree related to the data, calculates a hash value from the data, compares the hash value with a reference hash value, displays data different from the other data evaluated as not being tampered with in a case where it is evaluated that at least one of the data or the reference hash value is tampered with, compares the hash value with a top hash recorded in a blockchain, and displays data different from at least one of display of the other data evaluated as not being tampered with or display of data evaluated as at least one of the data or the reference hash value being tampered with in a case where it is evaluated that the acquired hash tree is normal.

### CROSS-REFERENCE TO RELATED APPLICATIONS

This application is a continuation application of International Application No. PCT/JP2024/039162 filed Nov. 1, 2024 the disclosure of which is incorporated herein by reference in its entirety. Further, this application claims priorities from Japanese Patent Application No. 2023-203244 filed Nov. 30, 2023, the disclosure of which is incorporated herein by reference in their entirety.

### BACKGROUND

### 1. Technical Field

The disclosed technology relates to an information processing method, an information processing device, an information display device, and an information processing program.

### 2. Description of the Related Art

JP7215581B discloses a supply chain management method of managing a transaction record (ReT) between each trader in a supply chain (SC) constructed including a plurality of traders (TR) by using a blockchain (BC). In particular, an aspect is disclosed in which, in a case where there is a reference request for item data via a user terminal, a data management server specifies a transaction record ReT related to the item data, further determines whether or not there is tampering possibility of the extracted transaction record ReT, and notifies a user terminal of an error in a case where the tampering possibility is estimated. In addition, regarding data verification, it is also disclosed that processing of calculating a Merkle root by combining hash values as the transaction record ReT in accordance with a shape of a Merkle tree is repeated.

WO2021/166528A discloses a fraud verification device used for verifying and detecting fraud performed in a blockchain. In particular, an aspect is disclosed in which a first Merkle root hash calculated from a block header of a block in a range to be targeted in a first blockchain and a block confirmation transaction including a Merkle root hash calculated based on a designated block number and a block header of the block from a second blockchain different from the first blockchain are specified, a second Merkle root hash is calculated from the block header in the specified block, and it is determined that a fraud operation (tampering) is performed in a transaction in any of the blocks in a case where the first Merkle root hash and the second Merkle root hash do not match each other by comparing the first Merkle root hash and the second Merkle root hash with each other in a case where the hash values do not match each other. In addition, an aspect is also disclosed in which, in a case where it is determined that the fraud operation is performed, an error is notified to a client device.

JP2023-522119A discloses a computer-implemented method of block propagation in a blockchain network. In particular, regarding block propagation from a mining node (miner) to another miner, an aspect is disclosed in which, in a case where a miner A receives a block header message indicating that a block is found from another miner C, the miner A constructs a Merkle tree based on a transaction ID (TXID) and an order designated for the miner C, and further verifies a hash value by hashing the block header.

### SUMMARY

Here, in a case where a hash value of data is generated at a time of creating the data, and it is checked that there is no difference between the hash value and a hash value generated again from the data to be referred to at a time of referring to the data, it is possible to check that the data is not tampered with. In addition to the data itself, in order to avoid a risk that the hash value generated at a time of creating the data is tampered with, the hash value may be registered in the blockchain. Since an operation of registering a value in the blockchain is costly, typically, a Merkle tree is created from a plurality of hash values, and only a top hash is registered in the blockchain. In that case, in order to check whether or not the data is tampered with, it is necessary to obtain a Merkle tree including a hash corresponding to the data and to obtain a top hash of the Merkle tree from the blockchain. In addition, it is necessary to check that the hash value of the data matches the hash value of the corresponding data included in the Merkle tree and that the Merkle tree is not tampered with. These processes take time. In order to quickly refer to the data, an issue is how to display a verification status in a case where the data before verification is displayed.

One aspect of the present invention is to provide an information processing method, an information processing device, an information display device, and an information processing program capable of displaying a verification status of data in a case where the data is referred to.

According to a first aspect of the present disclosure, there is provided an information processing method comprising: a step of acquiring one or more pieces of data; a step of acquiring a hash tree related to the data; a step of calculating a hash value from the data; a step of comparing the calculated hash value with a reference hash value obtained from the hash tree to evaluate whether at least one of the data or the reference hash value is tampered with or not tampered with; a step of displaying data different from the other data evaluated as not being tampered with in a case where it is evaluated that at least one of the data or the reference hash value is tampered with; a step of acquiring a top hash recorded in a blockchain for the hash tree; a step of comparing a top hash obtained from the hash tree with the top hash recorded in the blockchain to evaluate whether the acquired hash tree is normal or abnormal; and a step of displaying data different from at least one of display of the other data evaluated as not being tampered with or display of data evaluated as at least one of the data or the reference hash value being tampered with in a case where it is evaluated that the acquired hash tree is normal.

According to a second aspect of the present disclosure, there is provided an information processing device comprising: a processor, in which the processor is configured to: acquire one or more pieces of data; acquire a hash tree related to the data; calculate a hash value from the data; compare the calculated hash value with a reference hash value obtained from the hash tree to evaluate whether or not at least one of the data or the reference hash value is tampered with or not tampered with; display data different from the other data evaluated as not being tampered with in a case where it is evaluated that at least one of the data or the reference hash value is tampered with; acquire a top hash recorded in a blockchain for the hash tree; compare a top hash obtained from the hash tree with the top hash recorded in the blockchain to evaluate whether or not the acquired hash tree is normal or abnormal; and display data different from at least one of display of the other data evaluated as not being tampered with or display of data evaluated as having at least one of the data or the reference hash value tampered with in a case where it is evaluated that the acquired hash tree is normal.

According to a third aspect of the present disclosure, there is provided an information display device comprising: a processor, in which the processor is configured to display a user interface, the user interface includes a data display area that displays data, in which a hash value calculated from the data and a reference hash value are compared to evaluate whether at least one of the data or the reference hash value is tampered with or not tampered with, and the data display area displays data different from the other data evaluated as not being tampered with in a case where it is evaluated that at least one of the data or the reference hash value is tampered with, and further displays data different from at least one of display of the other data evaluated as not being tampered with or display of data evaluated as at least one of the data or the reference hash value being tampered with in a case where it is evaluated that a hash tree is normal.

According to a fourth aspect of the present disclosure, there is provided an information processing program causing a computer to execute a process comprising: acquiring one or more pieces of data; acquiring a hash tree related to the data; calculating a hash value from the data; comparing the calculated hash value with a reference hash value obtained from the hash tree to evaluate whether or not at least one of the data or the reference hash value is tampered with or not tampered with; displaying data different from the other data evaluated as not being tampered with in a case where it is evaluated that at least one of the data or the reference hash value is tampered with; acquiring a top hash recorded in a blockchain for the hash tree; comparing the top hash obtained from the hash tree with the top hash recorded in the blockchain to evaluate whether or not the acquired hash tree is normal or abnormal; and displaying data different from at least one of display of the other data evaluated as not being tampered with or display of data evaluated as having at least one of the data or the reference hash value tampered with in a case where it is evaluated that the acquired hash tree is normal.

According to one aspect, it is possible to display a verification status of data in a case where the data is referred to.

### BRIEF DESCRIPTION OF THE DRAWINGS

FIG. 1 is an explanatory diagram showing a configuration example of an information processing system.

FIG. 2 is a schematic block diagram of an example of a computer functioning as a server and a user terminal according to the present embodiment.

FIG. 3 is a block diagram showing a configuration of the server according to the present embodiment.

FIG. 4 is a block diagram showing a configuration of a data creation unit of the server according to the present embodiment.

FIG. 5 is a block diagram showing a configuration of a data verification unit of the server according to the present embodiment.

FIG. 6 is a diagram showing an example of displaying a verification status of data.

FIG. 7 is a flowchart showing a data creation processing routine in the server according to the present embodiment.

FIG. 8 is a flowchart showing a data verification processing routine in the server according to the present embodiment.

### DETAILED DESCRIPTION

Hereinafter, an example of an embodiment of the disclosed technology will be described with reference to the drawings. In each drawing, the same or equivalent constituent elements and parts are designated by the same reference numerals. In addition, dimensional ratios in the drawings are exaggerated for convenience of description and may be different from the actual ratios.

### System Configuration

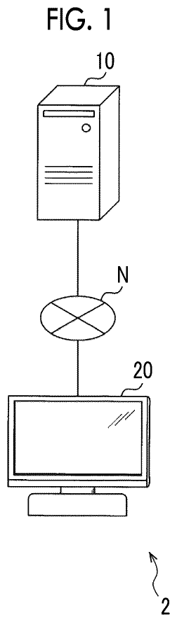

FIG. 1 is an explanatory diagram showing a configuration example of an information processing system 2. In the present embodiment, the information processing system 2 that performs data verification using a Merkle tree and a blockchain will be described. The information processing system 2 includes a server 10 and a user terminal 20. The server 10 and the user terminal 20 are communicably connected via a network N. The Merkle tree is an example of a hash tree. In addition, the server 10 is an example of an information processing device, and the user terminal 30 is an example of an information display device.

The data to be targeted may be any data such as data related to medical care or data related to inventory management.

The server 10 is, for example, a server computer capable of performing various types of information processing and transmitting and receiving information. The device corresponding to the server 10 is not limited to the server computer and may be, for example, a personal computer or the like. In the present embodiment, the server 10 functions as an information processing device that creates a Merkle tree or performs data verification using a Merkle tree and a blockchain in a case of data reference.

The user terminal 20 is a general-purpose computer such as a personal computer. In the present embodiment, the user terminal 20 functions as an information display device that displays a verification status of data in a case of data reference.

In the present embodiment, the server 10 creates a Merkle tree or performs data verification, but the local user terminal 20 may create a Merkle tree or perform data verification. That is, the distinction between the two is for convenience, and a single computer may perform a series of processes.

### Configuration of Server According to Present Embodiment

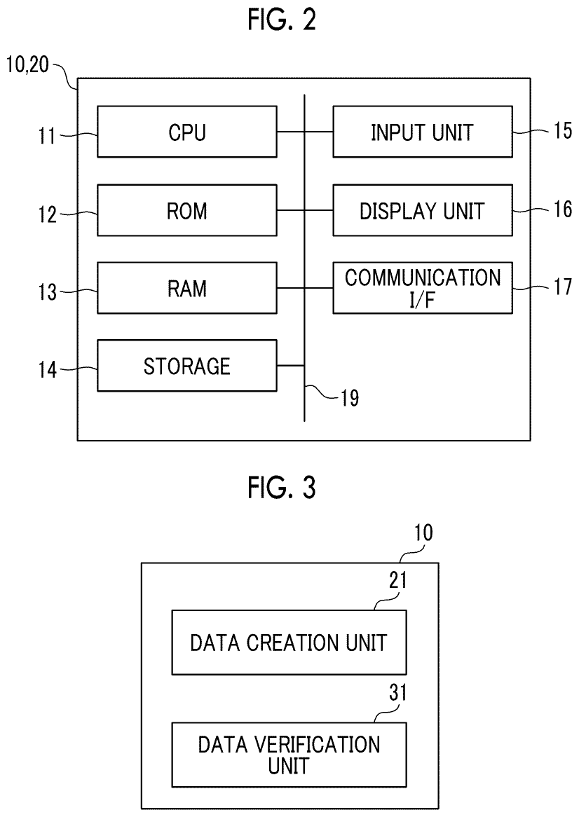

FIG. 2 is a block diagram showing a hardware configuration of the server 10 according to the present embodiment.

As shown in FIG. 2, the server 10 includes a central processing unit (CPU) 11, a read only memory (ROM) 12, a random access memory (RAM) 13, a storage 14, an input unit 15, a display unit 16, and a communication interface (I/F) 17. Each configuration is mutually communicably connected through a bus 19.

The CPU 11 is a central processing unit, and executes various programs or controls each unit. That is, the CPU 11 reads out a program from the ROM 12 or the storage 14 and executes the program using the RAM 13 as a work area. The CPU 11 controls each configuration and performs various types of arithmetic processing in accordance with the program stored in the ROM 12 or the storage 14. In the present embodiment, the ROM 12 or the storage 14 stores an information processing program for creating a Merkle tree and performing data verification. The information processing program may be one program or a program group composed of a plurality of programs or modules.

The ROM 12 stores various programs and various kinds of data. The RAM 13 temporarily stores a program or data as a work area. The storage 14 is configured with a hard disk drive (HDD) or a solid state drive (SSD), and stores various kinds of data and various programs including an operating system.

The input unit 15 includes a pointing device such as a mouse, and a keyboard, and is used to perform various inputs.

The input unit 15 receives newly created data.

The display unit 16 is, for example, a liquid crystal display and displays various types of information. The display unit 16 may adopt a touch panel type to function as the input unit 15.

The communication interface 17 is an interface for communicating with other devices, and standards such as Ethernet (registered trademark), FDDI, and Wi-Fi (registered trademark) are used.

Next, a functional configuration of the server 10 will be described. FIG. 3 is a block diagram showing an example of a functional configuration of the server 10.

Functionally, as shown in FIG. 3, the server 10 is configured to include a data creation unit 21 and a data verification unit 31.

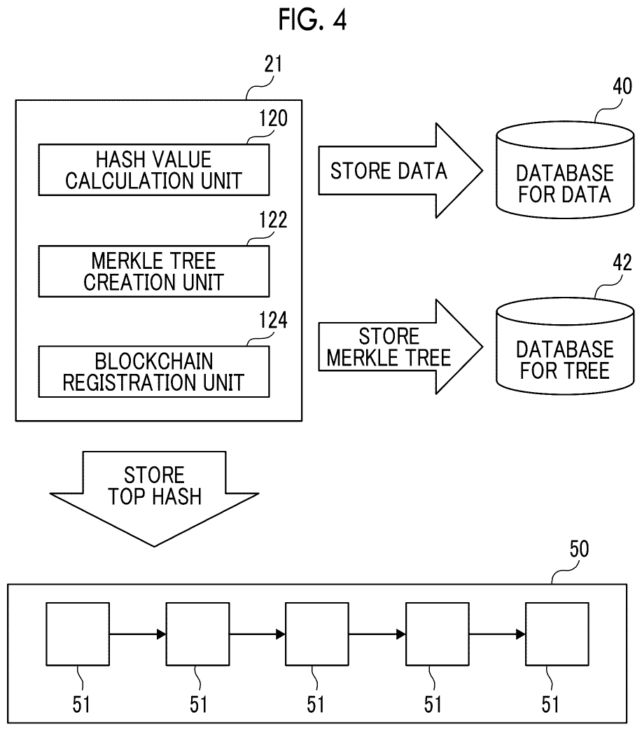

The data creation unit 21 creates a Merkle tree from newly created data and registers a top hash of the Merkle tree in the blockchain. Specifically, as shown in FIG. 4, the data creation unit 21 includes a hash value calculation unit 120, a Merkle tree creation unit 122, and a blockchain registration unit 124.

The hash value calculation unit 120 stores the newly created data in the external database for data 40 and calculates a hash value from the data. The hash corresponding to the individual data is a hash calculated by a hash function from the input data at any time.

The Merkle tree creation unit 122 creates a Merkle tree each time a certain number of hash values calculated from the newly created data are obtained, and stores the created Merkle tree in the external database for a tree 42. Here, in the Merkle tree, the hash value of each data is stored in each leaf node, one hash value newly calculated for data obtained by combining the hash values of two lower nodes is stored in an upper node, and a top hash is stored in a top node.

The blockchain registration unit 124 registers the top hash of the created Merkle tree and an ID for specifying the Merkle tree on the blockchain 50. The blockchain 50 is constructed by a blockchain network composed of a plurality of computer terminals, and is obtained by connecting blocks 51 including the top hash of the Merkle tree and the ID for specifying the Merkle tree in time series. The blockchain registration unit 124 can prevent tampering with the Merkle tree by registering the top hash in the block 51 on the blockchain 50 each time the Merkle tree is created.

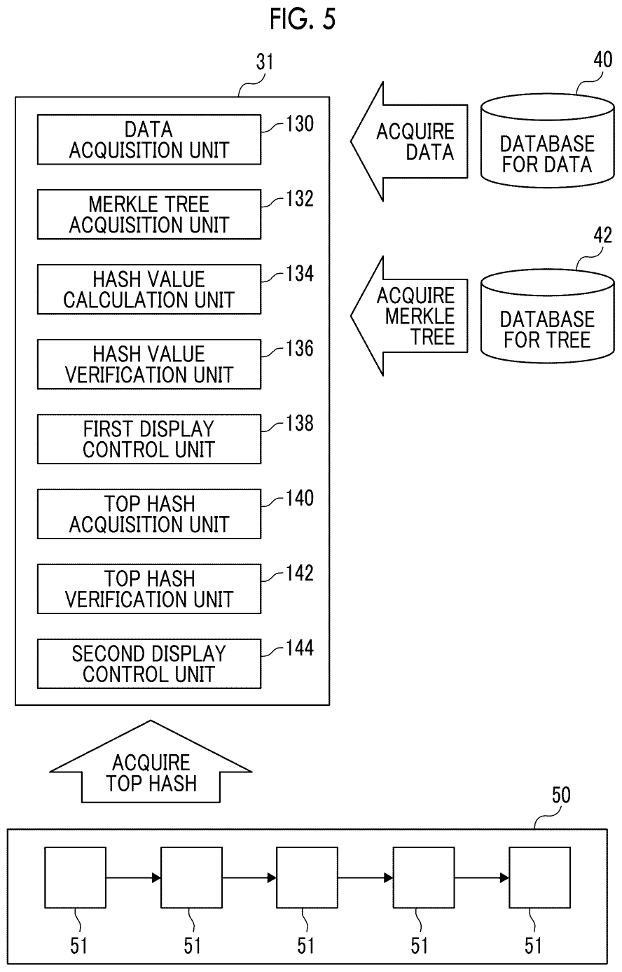

The data verification unit 31 verifies the data using the Merkle tree and the blockchain 50 in a case where the user terminal 30 refers to the data. Specifically, as shown in FIG. 5, the data verification unit 31 includes a data acquisition unit 130, a Merkle tree acquisition unit 132, a hash value calculation unit 134, a hash value verification unit 136, a first display control unit 138, a top hash acquisition unit 140, a top hash verification unit 142, and a second display control unit 144.

The data acquisition unit 130 acquires one or more data to be referred to by the user terminal 30 from the database for data 40.

The Merkle tree acquisition unit 132 acquires the Merkle tree related to the data to be referred to by the user terminal 30 from the database for a tree 42.

The hash value calculation unit 134 calculates the hash value from the data to be referred to by the user terminal 30.

The hash value verification unit 136 compares the calculated hash value with the reference hash value obtained from the Merkle tree to evaluate whether at least one of the data or the reference hash value is tampered with or the data is not tampered with.

Specifically, the reference hash value corresponding to the data to be referred to by the user terminal 30 is acquired from the Merkle tree acquired by the Merkle tree acquisition unit 132, and the hash value calculated by the hash value calculation unit 134 is compared with the reference hash value. In a case where the hash value calculated by the hash value calculation unit 134 and the reference hash value do not match, it is evaluated that at least one of the data or the reference hash value is tampered with. On the other hand, in a case where the hash value calculated by the hash value calculation unit 134 and the reference hash value match, it is evaluated that the data is not tampered with.

In a case where it is evaluated that at least one of the data or the reference hash value is tampered with, the first display control unit 138 causes the display unit 16 of the user terminal 30 to display data different from other data evaluated that the data is not tampered with.

In addition, in a case where it is evaluated that the data is not tampered with, the first display control unit 138 causes the display unit 16 of the user terminal 30 to display data different from other data evaluated that at least one of the data or the reference hash value is tampered with.

The top hash acquisition unit 140 acquires the top hash recorded on the blockchain 50 for the Merkle tree acquired by the Merkle tree acquisition unit 132. Specifically, the top hash is acquired from the block 51 including the ID using the ID of the Merkle tree acquired by the Merkle tree acquisition unit 132.

The top hash verification unit 142 compares the top hash obtained from the Merkle tree with the top hash recorded on the blockchain 50 to evaluate whether the acquired Merkle tree is normal or abnormal.

In a case where it is evaluated that the Merkle tree is normal, the second display control unit 144 causes the display unit 16 of the user terminal 30 to perform the following display. The second display control unit 144 causes the display unit 16 to display data different from any one of the display of the data evaluated that the data is not tampered with or the display of the data evaluated that at least one of the data or the reference hash value is tampered with.

In addition, in a case where it is evaluated that the acquired Merkle tree is abnormal, the second display control unit 144 causes the display unit 16 of the user terminal 30 to perform the following display. The second display control unit 144 causes the display unit 16 to display data different from any one of the display of the data evaluated that the data is not tampered with or the display of the data evaluated that at least one of the data or the calculated hash value is tampered with.

### Configuration of User Terminal According to Present Embodiment

FIG. 2 is a block diagram showing a hardware configuration of the user terminal 20 according to the present embodiment.

As shown in FIG. 2, the user terminal 20 includes a CPU 11, a ROM 12, a RAM 13, a storage 14, an input unit 15, a display unit 16, and a communication interface (I/F) 17, similarly to the server 10. Each configuration is mutually communicably connected through a bus 19.

An information display program for displaying data is stored in the ROM 12 or the storage 14. The program may be one program or a program group composed of a plurality of programs or modules.

The input unit 15 receives designation of data as a reference target. For example, identification information of medical data or inventory data is received.

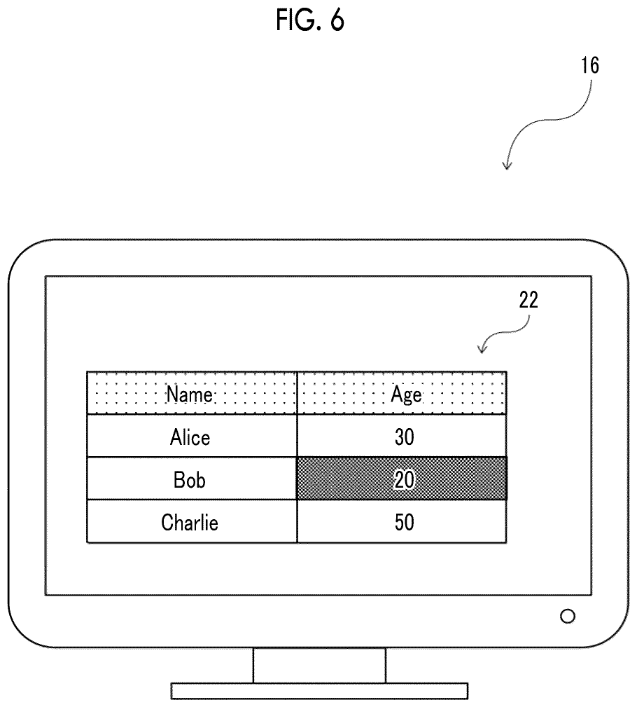

As shown in FIG. 6, the CPU 11 displays a user interface 22 on the display unit 16.

The user interface 22 is a data display area that displays a list of data as a reference target. In the data display area, a result of evaluating whether at least one of the data or the calculated hash value is tampered with or not tampered with is displayed by comparing the hash value calculated from the data with the reference hash value.

In addition, in a case where it is evaluated that at least one of the data or the reference hash value is tampered with, the data display area displays data different from the other data evaluated as not being tampered with. Further, in a case where it is evaluated that the Merkle tree is normal, the following display is performed. Data different from at least one of the display of other data not being tampered with or the display of data evaluated as at least one of the data or the reference hash value being tampered with is displayed.

For example, a background color of data being verified is set to “yellow”, and a background color of data for which it is confirmed that the data is not tampered with is set to “green”. In addition, a background color of data for which it is confirmed that the data is tampered with is set to “red”. In addition, since the Merkle tree is tampered with, a background color of data for which it is not possible to confirm whether the data to be referred to is tampered with is set to “orange”.

In addition to the setting of the background color of the data, icons having different shapes may be displayed, or icons having different shapes may be displayed instead of the setting of the background color. In setting the color, the color may be continuously changed according to the progress of the verification. A progress or a result may be displayed as a character string in addition to the display of the color or the icon, or a progress or a result may be displayed as a character string instead of the display of the color or the icon.

FIG. 6 shows an example of a case where data of “Bob” as a Name and “20” as an Age is evaluated as being tampered with.

In the example of FIG. 6, there are the following variations in the data for which the hash is calculated. That is, the hash may be calculated for a combination of the Name and the Age, or the hash may be calculated for any single element of the Name or the Age. In addition, the hash may be calculated for the entire table, the entire row, or each cell. In addition, the hash may be calculated for a single important element, and the hash may be calculated for a group of secondary elements.

In a case where the target data is data related to an order (for example, an order placement, a delivery date response, or a purchase order), the hash is calculated for the data, and in a case where the Merkle tree is created, the top hash is added as a block to the blockchain. In a case where the delivery date response is received, the hash is calculated, and in a case where the Merkle tree is created, the top hash is added as a block to the blockchain. In a case where the delivery date is updated, the same processing is performed. In a case where a large number of data elements are combined to be defined as one data, the data verification processing is lightened. On the contrary, in a case where a single element is defined as one data, the data verification processing is heavy, but the data verification status is easily visually recognized on the user interface. It is preferable to calculate the hash for important information such as the price as a single data.

### Operation of Server 10 According to Present Embodiment

Next, the operation of the server 10 according to the present embodiment will be described.

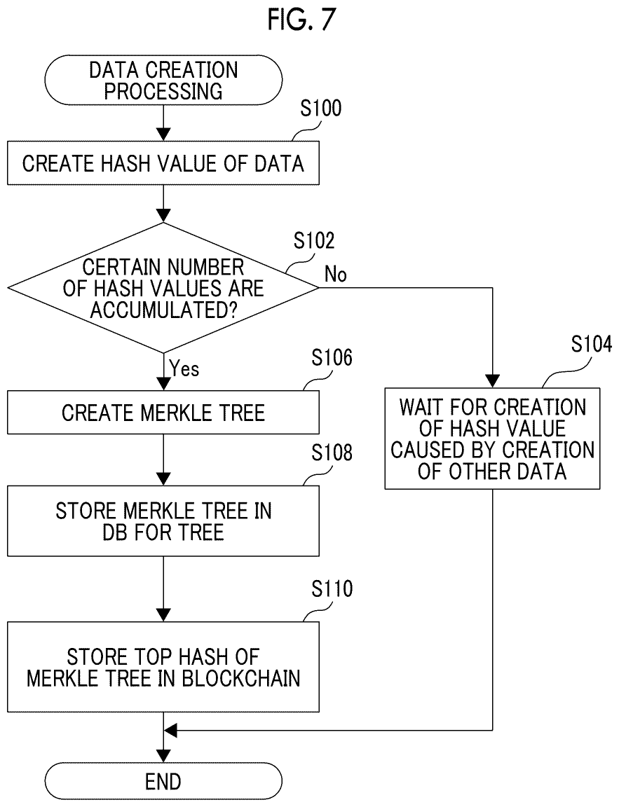

First, the CPU 11 reads out the information processing program from the ROM 12 or the storage 14, loads the information processing program into the RAM 13, and executes the information processing program, thereby performing the data creation processing shown in FIG. 7. In addition, it is assumed that the newly created data is input to the server 10.

First, in step S100, the CPU 11, as the hash value calculation unit 120, stores the newly created data in the external database for data 40 and creates the hash value from the data.

In step S102, the CPU 11, as the Merkle tree creation unit 122, determines whether or not a certain number of the hash values created in step S100 are accumulated. For example, in a case where eight hash values of the newly created data are accumulated, it is determined that a certain number of the hash values are accumulated, and the processing proceeds to step S106. On the other hand, in a case where the certain number of the hash values of the newly created data are not accumulated, the processing proceeds to step S104.

In step S104, the CPU 11 determines to wait for the creation of the hash value caused by the creation of other data, and ends the data creation processing.

In step S106, the CPU 11, as the Merkle tree creation unit 122, creates the Merkle tree by using the certain number of the hash values calculated from the newly created data.

In step S108, the CPU 11, as the Merkle tree creation unit 122, stores the created Merkle tree in the external database for a tree 42.

In step S110, the CPU 11, as the blockchain registration unit 124, registers the top hash of the created Merkle tree in the block 51 on the blockchain 50, and ends the data creation processing.

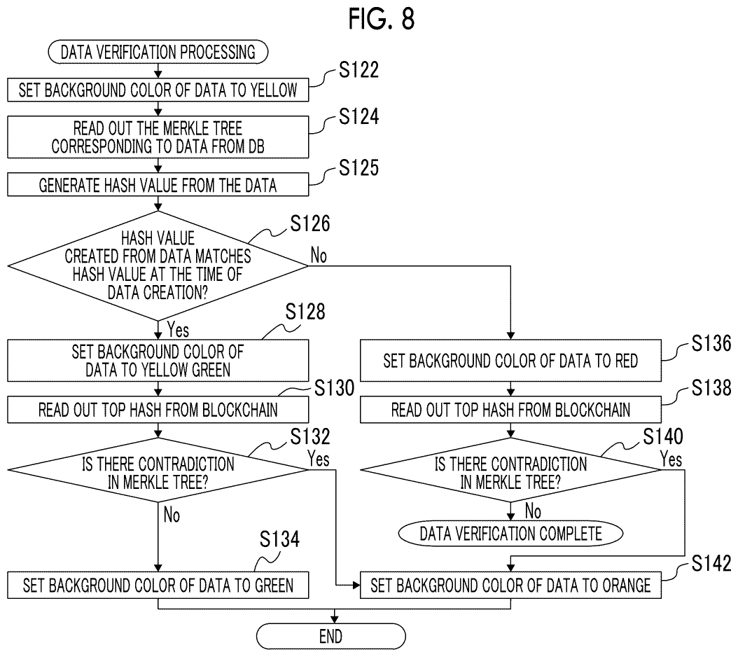

Next, the CPU 11 reads out the information processing program from the ROM 12 or the storage 14, and loads and executes the information processing program in the RAM 13, thereby performing the data verification processing shown in FIG. 8. In addition, it is assumed that the data reference request is input to the server 10 from the user terminal 30, and the CPU 11, as the data acquisition unit 130, acquires one or more pieces of data to be referred to by the user terminal 30 from the database for data 40.

This data verification processing is repeatedly executed for each of one or more pieces of data to be referred to by the user terminal 30 as a processing target.

First, in step S122, the CPU 11 sets the background color of the data as the processing target to yellow in the list representing one or more pieces of data to be referred to, and displays the list representing one or more pieces of data to be referred to on the display unit 16 of the user terminal 30. As a result, the user can understand that the data is being verified.

In step S124, the CPU 11, as the Merkle tree acquisition unit 132, reads out the Merkle tree related to the data to be referred to by the user terminal 30 from the database for tree 42.

In step S125, the CPU 11, as the hash value calculation unit 134, generates a hash value from the data as the processing target.

In step S126, the CPU 11, as the hash value verification unit 136, determines whether or not the hash value created in step S125 and the reference hash value at the time of data creation obtained from the Merkle tree match. In a case where the hash value created in step S125 and the reference hash value at the time of data creation obtained from the Merkle tree match, it is evaluated that the data is not tampered with, and the processing proceeds to step S128.

On the other hand, in a case where the hash value created in step S125 and the reference hash value at the time of data creation obtained from the Merkle tree do not match, it is evaluated that at least one of the data or the reference hash value is tampered with, and the processing proceeds to step S136.

In step S128, the CPU 11, as the first display control unit 138, causes the display unit 16 of the user terminal 30 to perform the following display. The data as the processing target is displayed in a manner different from other data for which it is evaluated that at least one of the data or the reference hash value is tampered with. Specifically, in the list representing one or more data as the reference target, the background color of the data as the processing target is set to yellow green, and the list representing one or more data as the reference target is displayed on the display unit 16 of the user terminal 30. As a result, the user can ascertain that it has been confirmed that the data is not tampered with.

In step S130, the CPU 11, as the top hash acquisition unit 140, reads out the top hash recorded on the blockchain 50 for the Merkle tree acquired in step S124.

In step S132, the CPU 11, as the top hash verification unit 142, compares the top hash of the Merkle tree acquired in step S124 with the top hash read out in step S130 and recorded on the blockchain 50. As a result, the CPU 11 determines whether or not there is a contradiction in the acquired Merkle tree. In a case where the top hash of the Merkle tree acquired in step S124 and the top hash read out in step S130 and recorded on the blockchain 50 match, it is evaluated that the acquired Merkle tree is normal. Then, the process proceeds to step S134. On the other hand, in a case where the top hash of the Merkle tree acquired in step S124 and the top hash read out in step S130 and recorded on the blockchain 50 do not match, it is evaluated that the acquired Merkle tree is abnormal. Then, the process proceeds to step S142.

In step S134, the CPU 11, as the second display control unit 144, causes the display unit 16 of the user terminal 30 to perform the following display. For the data to be processed, the second display control unit 144 causes the display unit 16 to display data different from any one of the display of the data evaluated that the data is not tampered with or the display of the data evaluated that at least one of the data or the reference hash value is tampered with. Then, the data verification processing is ended.

Specifically, in the list representing one or more pieces of data to be referenced, the background color of the data to be processed is set to green, and the list representing one or more pieces of data to be referenced is displayed on the display unit 16 of the user terminal 30. As a result, the user can ascertain that the data and the Merkle tree have been checked to be not tampered with.

In step S136, the CPU 11, as the first display control unit 138, causes the display unit 16 of the user terminal 30 to display data different from other data evaluated as at least one of the data or the reference hash value being tampered with for the data to be processed. Specifically, in the list representing one or more pieces of data to be referenced, the background color of the data to be processed is set to red, and the list representing one or more pieces of data to be referenced is displayed on the display unit 16 of the user terminal 30. As a result, the user can ascertain that the data has been tampered with.

In step S138, the CPU 11, as the top hash acquisition unit 140, reads out the top hash recorded on the blockchain 50 for the Merkle tree acquired in step S124.

In step S140, the CPU 11, as the top hash verification unit 142, compares the top hash of the Merkle tree acquired in step S124 with the top hash read out in step S130 and recorded on the blockchain 50. As a result, the CPU 11 determines whether or not there is a contradiction in the acquired Merkle tree. In a case where the top hash of the Merkle tree acquired in step S124 and the top hash read out in step S138 and recorded on the blockchain 50 match, the acquired Merkle tree is evaluated as normal, and the data verification processing is ended. On the other hand, in a case where the top hash of the Merkle tree acquired in step S124 and the top hash read out in step S138 and recorded on the blockchain 50 do not match, the acquired Merkle tree is evaluated as abnormal. Then, the process proceeds to step S142.

In step S142, the CPU 11, as the second display control unit 144, causes the display unit 16 of the user terminal 30 to display the following. The display of the data evaluated as not being tampered with and the display of the data evaluated as at least one of the data or the calculated hash value being tampered with are displayed for the data to be processed, and the display of different data is performed. Then, the data verification processing is ended. Specifically, in the list representing one or more data to be referred to, the background color of the data to be processed is set to orange, and the list representing one or more data to be referred to is displayed on the display unit 16 of the user terminal 30. As a result, the user can understand that the Merkle tree is tampered with and that it is not possible to check whether or not the data is tampered with.

As described above, with the information processing system according to the present exemplary embodiment, in displaying the data on the user terminal, the verification for checking that the data is not tampered with is executed by the server, and the result of the verification or the progress status of the verification is displayed on the user terminal. As described above, in a case of referring to the data, the result of the verification of the data or the verification status indicating the progress of the verification can be displayed.

### Modification Example

The present invention is not limited to the above-described exemplary embodiments, and various modifications and applications can be made without departing from the gist of the present invention.

For example, various processors other than the CPU may execute various types of processing executed by the CPU reading software (program) in each of the above-described exemplary embodiments. Examples of the processors in this case include a programmable logic device (PLD) of which a circuit configuration can be changed after manufacture, such as a field-programmable gate array (FPGA), and a dedicated electric circuit that is a processor having a circuit configuration dedicatedly designed to execute specific processing, such as an application specific integrated circuit (ASIC). In addition, the data creation processing and the data verification processing may be executed by one of the various processors, or may be executed by a combination of two or more processors of the same type or different types (for example, a plurality of FPGAs, a combination of a CPU and an FPGA, or the like). Furthermore, the hardware structures of the various processors are more specifically electrical circuitry where circuit elements, such as semiconductor elements, are combined.

Additionally, in the above-described embodiment, an aspect has been described in which the information processing program is stored (installed) in advance in the storage 14, but the present disclosure is not limited to this aspect. The program may be provided in a form stored in a non-transitory storage medium such as a compact disk read only memory (CD-ROM), a digital versatile disk read only memory (DVD-ROM), and a universal serial bus (USB) memory. Alternatively, a form in which the program is downloaded from an external apparatus through a network may be available.

The embodiments disclosed this time should be considered to be merely examples and not restrictive in all respects. The scope of the present invention is not limited to the above meaning, but is indicated by the scope of the claims, and is intended to include all modifications within the meaning and scope equivalent to the scope of the claims.

The following supplementary notes are further disclosed with respect to the above embodiment.

### Supplementary Note 1

An information processing method comprising:
a step of acquiring one or more pieces of data;
a step of acquiring a hash tree related to the data;
a step of calculating a hash value from the data;
a step of comparing the calculated hash value with a reference hash value obtained from the hash tree to evaluate whether at least one of the data or the reference hash value is tampered with or not tampered with;
a step of displaying data different from the other data evaluated as not being tampered with in a case where it is evaluated that at least one of the data or the reference hash value is tampered with;
a step of acquiring a top hash recorded in a blockchain for the hash tree;
a step of comparing a top hash obtained from the hash tree with the top hash recorded in the blockchain to evaluate whether the acquired hash tree is normal or abnormal; and
a step of displaying data different from at least one of display of the other data evaluated as not being tampered with or display of data evaluated as at least one of the data or the reference hash value being tampered with in a case where it is evaluated that the acquired hash tree is normal.

### Supplementary Note 2

The information processing method according to Supplementary Note 1, further comprising:
a step of displaying data different from other data evaluated as at least one of the data or the reference hash value being tampered with in a case where it is evaluated that the data is not tampered with; and
a step of displaying data different from any one of display of the data evaluated as not being tampered with or display of the data evaluated as at least one of the data or the reference hash value being tampered with in a case where it is evaluated that the hash tree is abnormal.

### Supplementary Note 3

The information processing method according to Supplementary Note 2, further comprising:
a step of displaying data different from any one of display of the data evaluated as not being tampered with or display of the data evaluated as at least one of the data or the reference hash value being tampered with in a case where it is evaluated that the hash tree is normal.

### Supplementary Note 4

The information processing method according to any one of Supplementary Notes 1 to 3,
in which a hash corresponding to individual data is a hash calculated from input data by a hash function.

### Supplementary Note 5

An information processing device comprising:
a processor,
in which the processor is configured to:
   acquire one or more pieces of data;
   acquire a hash tree related to the data;
   calculate a hash value from the data;
   compare the calculated hash value with a reference hash value obtained from the hash tree to evaluate whether at least one of the data or the reference hash value is tampered with or not tampered with;
   display data different from the other data evaluated as not being tampered with in a case where it is evaluated that at least one of the data or the reference hash value is tampered with;
   acquire a top hash recorded in a blockchain for the hash tree;
   compare a top hash obtained from the hash tree with the top hash recorded in the blockchain to evaluate whether the acquired hash tree is normal or abnormal; and
   display data different from at least one of display of the other data evaluated as not being tampered with or display of data evaluated as at least one of the data or the reference hash value being tampered with in a case where it is evaluated that the acquired hash tree is normal.

### Supplementary Note 6

An information display device comprising:
a processor,
in which the processor is configured to display a user interface,
the user interface includes a data display area that displays data, in which a hash value calculated from the data and a reference hash value are compared to evaluate whether at least one of the data or the reference hash value is tampered with or not tampered with, and
the data display area
   displays data different from the other data evaluated as not being tampered with in a case where it is evaluated that at least one of the data or the reference hash value is tampered with, and
   further displays data different from at least one of display of the other data evaluated as not being tampered with or display of data evaluated as at least one of the data or the reference hash value being tampered with in a case where it is evaluated that a hash tree is normal.

### Supplementary Note 7

An information processing program causing a computer to execute a process comprising:
acquiring one or more pieces of data;
acquiring a hash tree related to the data;
calculating a hash value from the data;
comparing the calculated hash value with a reference hash value obtained from the hash tree to evaluate whether at least one of the data or the reference hash value is tampered with or not tampered with;
displaying data different from the other data evaluated as not being tampered with in a case where it is evaluated that at least one of the data or the reference hash value is tampered with;
acquiring a top hash recorded in a blockchain for the hash tree;
comparing a top hash obtained from the hash tree with the top hash recorded in the blockchain to evaluate whether the acquired hash tree is normal or abnormal; and
displaying data different from at least one of display of the other data evaluated as not being tampered with or display of data evaluated as at least one of the data or the reference hash value being tampered with in a case where it is evaluated that the acquired hash tree is normal.

The disclosure of JP2023-203244A is incorporated in the present specification by reference.

All documents, patent applications, and technical standards described in the present specification are herein incorporated by reference to the same extent that each individual document, patent application, or technical standard was specifically and individually indicated to be incorporated by reference.

What is claimed is:

1. An information processing method comprising:
a step of acquiring one or more pieces of data;
a step of acquiring a hash tree related to the data;
a step of calculating a hash value from the data;
a step of comparing the calculated hash value with a reference hash value obtained from the hash tree to evaluate whether at least one of the data or the reference hash value is tampered with or not tampered with;
a step of displaying data different from the other data evaluated as not being tampered with in a case where it is evaluated that at least one of the data or the reference hash value is tampered with;
a step of acquiring a top hash recorded in a blockchain for the hash tree;
a step of comparing a top hash obtained from the hash tree with the top hash recorded in the blockchain to evaluate whether the acquired hash tree is normal or abnormal; and
a step of displaying data different from at least one of display of the other data evaluated as not being tampered with or display of data evaluated as at least one of the data or the reference hash value being tampered with in a case where it is evaluated that the acquired hash tree is normal.

2. The information processing method according to claim 1, further comprising:
a step of displaying data different from other data evaluated as at least one of the data or the reference hash value being tampered with in a case where it is evaluated that the data is not tampered with; and
a step of displaying data different from any one of display of the data evaluated as not being tampered with or display of the data evaluated as at least one of the data or the reference hash value being tampered with in a case where it is evaluated that the hash tree is abnormal.

3. The information processing method according to claim 2, further comprising:
a step of displaying data different from any one of display of the data evaluated as not being tampered with or display of the data evaluated as at least one of the data or the reference hash value being tampered with in a case where it is evaluated that the hash tree is normal.

4. The information processing method according to claim 1,
wherein a hash corresponding to individual data is a hash calculated from input data by a hash function.

5. An information processing device comprising:
a processor,
the processor being configured to:
acquire one or more pieces of data;
acquire a hash tree related to the data;
calculate a hash value from the data;
compare the calculated hash value with a reference hash value obtained from the hash tree to evaluate whether at least one of the data or the reference hash value is tampered with or not tampered with;
display data different from the other data evaluated as not being tampered with in a case where it is evaluated that at least one of the data or the reference hash value is tampered with;
acquire a top hash recorded in a blockchain for the hash tree;
compare a top hash obtained from the hash tree with the top hash recorded in the blockchain to evaluate whether the acquired hash tree is normal or abnormal; and
display data different from at least one of display of the other data evaluated as not being tampered with or display of data evaluated as at least one of the data or the reference hash value being tampered with in a case where it is evaluated that the acquired hash tree is normal.

6. An information display device comprising:
a processor,
the processor being configured to display a user interface,
the user interface includes a data display area that displays data, in which a hash value calculated from the data and a reference hash value are compared to evaluate whether at least one of the data or the reference hash value is tampered with or not tampered with, and
the data display area
displays data different from the other data evaluated as not being tampered with in a case where it is evaluated that at least one of the data or the reference hash value is tampered with, and
further displays data different from at least one of display of the other data evaluated as not being tampered with or display of data evaluated as at least one of the data or the reference hash value being tampered with in a case where it is evaluated that a hash tree is normal.

7. A non-transitory storage medium storing a program executable by a computer so as to execute information processing, the information processing including:
acquiring one or more pieces of data;
acquiring a hash tree related to the data;
calculating a hash value from the data;
comparing the calculated hash value with a reference hash value obtained from the hash tree to evaluate whether at least one of the data or the reference hash value is tampered with or not tampered with;
displaying data different from the other data evaluated as not being tampered with in a case where it is evaluated that at least one of the data or the reference hash value is tampered with;
acquiring a top hash recorded in a blockchain for the hash tree;
comparing a top hash obtained from the hash tree with the top hash recorded in the blockchain to evaluate whether the acquired hash tree is normal or abnormal; and
displaying data different from at least one of display of the other data evaluated as not being tampered with or display of data evaluated as at least one of the data or the reference hash value being tampered with in a case where it is evaluated that the acquired hash tree is normal.
